(19) United States
(12) Patent Application Publication
(10) Pub. No.: US 2007/0294217 A1
(43) Pub. Date: Dec. 20, 2007

(54) SAFETY GUARANTEE OF CONTINUOUS JOIN QUERIES OVER PUNCTUATED DATA STREAMS

(75) Inventors: Songting Chen, San Jose, CA (US); Hua-Gang Li, San Jose, CA (US); Junichi Tatemura, Sunnyvale, CA (US); Wang-Pin Hsiung, Santa Clara, CA (US); Divyakant Agrawal, Goleta, CA (US); Kasim Selcuk Candan, Tempe, AZ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 11/691,640

(22) Filed: Mar. 27, 2007

Related U.S. Application Data
(60) Provisional application No. 60/804,673, filed on Jun. 14, 2006.
(60) Provisional application No. 60/804,667, filed on Jun. 14, 2006.
(60) Provisional application No. 60/804,669, filed on Jun. 14, 2006.
(60) Provisional application No. 60/868,824, filed on Dec. 6, 2006.

(51) Int. Cl. G06F 17/30

(52) U.S. Cl. 707/2

(57) ABSTRACT

Systems and methods are disclosed to guarantee the safety of a continuous join query (CJQ) over one or more punctuated data streams by constructing a punctuation graph; checking whether the punctuation graph is strongly connected and if so, indicating that the CJQ is safe to execute. The system uses a generalized punctuation graph and its transformation to support arbitrary punctuation schemes. The system also provides an efficient shared purge algorithm for multi-way join operator.

This application claims priority to Provisional Application Ser. Nos. 60/804,673 (filed on Jun. 14, 2006), 60/804,667 (filed on Jun. 14, 2006), 60/804,669 (filed on Jun. 14, 2006), and 60/868,824 (filed on Dec. 6, 2006), the contents of which are incorporated by reference.

### BACKGROUND

The instant invention relates to determining the safety of continuous join queries and an efficient punctuation-aware multi-way join algorithm.

Recent years have witnessed the growth of newly emerging online applications in which data arrives in a streaming format at high speed. For instance, financial applications process streams of stock market or credit card transactions, telephone call monitoring applications process streams of call-detail records, network traffic monitoring applications process streams of network traffic data, and sensor network monitoring applications process streams of environmental data gathered by sensors. In these applications, inputs to processing modules take the form of continuous (and potentially infinite) data streams, rather than finite stored data sets. Also, it is quite often that applications require long-running continuous queries as opposed to the traditional one-time queries.

One fundamental problem for processing continuous queries is that since the data streams are potentially infinite, traditional relational operators, which are well-defined based on finite data, become no longer appropriate. For instance, two highly common operator types are known to be inappropriate for processing infinite data streams: blocking operators, such as groupby, and stateful operators, such as join operators. A blocking operator may never emit a single result, while a stateful operator may require infinite states and eventually run out of space. To address these problems, stream punctuation semantics was recently introduced into the data stream context. A punctuation is a “predicate” which denotes that no future stream tuples will satisfy this predicate. Thus, based on a given punctuation, stateful and blocking operators may be able to purge data that will no longer contribute to any new results or emit the blocked results, respectively. In short, punctuation semantics break the infinite semantics in the streaming context to avoid infinite memory consumption and infinite blocking.

FIG. 1 shows an online auction as a running example. In FIG. 1, the item stream contains items posted by sellers and each item tuple has four attributes; namely, (sellerid; itemid; name; initialprice). The bid stream contains the bids posted by buyers and a bid tuple contains three attributes, (bidderid; itemid; increase). A sample query in this scenario would be to “track the difference between the final price and the initial price for each item”. This can be done by (a) joining the item stream and bid stream on their respective itemids and then (b) summing up the increase values for each item seen in the streams. However, without any application knowledge, throughout the auction, the system has to keep all incoming tuples from both data streams, since any stored tuple may join with a future incoming tuple in the other stream. Thus the query will require infinite join state storage (and the system will eventually break down).

With appropriate punctuations, this stateful problem can be resolved: if each itemid is unique in the item stream, then each incoming bid tuple can join with only a single item tuple. Thus, as soon as the corresponding item tuple arrives, the corresponding bid tuples can be purged from the system. When the auction for one item with itemid=1 is closed, then no more bids for the item with itemid=1 will be inserted into the bid stream. As a consequence, if this information is available (through a punctuation) the join operator can purge the item tuple with itemid=1. Furthermore, the groupby operator can now output the result for this item.

In the example, if the punctuation scheme shows that there are only punctuations on bidderid from bid stream, then the item stream in the above query can never be purged and the stateful problem remains unsolved. Such a query is “unsafe” and should not be processed to avoid infinite memory consumption and infinite blocking.

### SUMMARY

Systems and methods are disclosed to guarantee the safety of a continuous join query (CJQ) over one or more punctuated data streams by constructing a punctuation graph; checking whether the punctuation graph is strongly connected and if so, indicating that the CJQ is safe to execute. The system includes a generalized punctuation graph and checking procedure for handling CJQ with complex join predicates and an efficient punctuation-aware multi-way join algorithm.

Implementations of the above aspect may include one or more of the following. The system uses a generalized strategy called chained purge strategy that serves as the basis for the safety checking of continuous join queries. A graph representation, namely the punctuation graph, captures the relationship between the punctuation schemes and the join conditions for checking the safety of continuous join queries. A generalization of the punctuation graph supports punctuation schemes which has more than one constant value attribute. The system efficiently determines the safety of a continuous join query based on the punctuation graph representation. The system provides an enumeration of safe execution plans. The system can also support a new framework for adapting other relational operators to the streaming punctuation semantics as well as the safety checking of an arbitrary SQL-style streaming query.

Advantages of the system may include one or more of the following. The safety checking of continuous join queries under punctuation semantics protects against unlimited space consumption during query processing. The system can identify if and how a particular continuous query could benefit from the punctuations (or more precisely, punctuation schemes) available in the system. The system provides safety checking of the continuous join queries (CJQs) given a set of available punctuation schemes for binary join queries as well as multi-way join queries. The safety checking procedure efficiently runs in linear time and avoids the exponential enumeration of execution plans of a continuous join query. The system automatically chooses a safe execution plan for a continuous join query for binary join queries (as shown in the above auction example) and for join queries that are over more than two data streams (multi-way join). The system decides if a particular query can be safely executed without having to enumerate all possible execution plans. The system provides an automatic safety checking mechanism for CJQs over data streams under a given set of punctuation schemes and enables a streaming query engine to (1) identify those unsafe queries, which may eventually consume all the system resources; and (2) provide a guideline of how to process those safe queries.

### BRIEF DESCRIPTION OF THE DRAWINGS

FIG. 1 shows an online auction.

FIG. 2 depicts an overview of a general data stream management system.

FIG. 3 shows an example 3-way join operator.

FIG. 4 shows an example of the operation of a chained purge strategy.

FIG. 5 shows the punctuation graph of a 3-way join operator under a given punctuation scheme set.

FIG. 6 shows an example 3-way join with arbitrary punctuation schemes.

FIG. 7 shows the generalized punctuation graph for FIG. 6.

FIG. 8 shows a transformation of the generalized punctuation graph.

FIG. 9 shows 4 purge chains for a 4-way join operator.

FIG. 10 shows the 4 chains in FIG. 9 can be shared through peer propagation.

FIG. 11 shows an exemplary process to construct a punctuation graph.

FIG. 12 shows an exemplary process to perform CJQ safety checking.

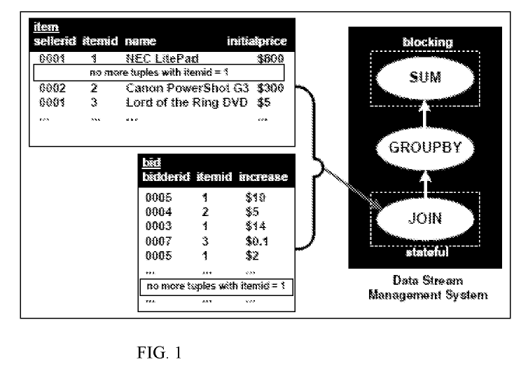

### DESCRIPTION

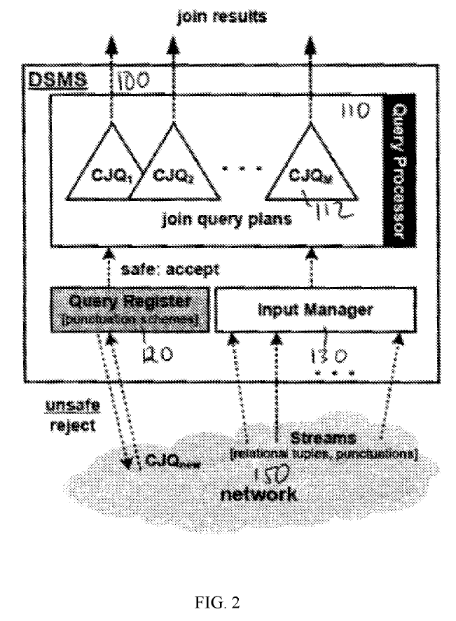

FIG. 2 depicts an overview of a general data stream management system (DSMS) system architecture. Here the input manager accepts and buffers the stream data and punctuations from the application environment. The query processor processes the stream data and punctuations for the registered continuous join queries (CJQs). Preferably, the system should allow only those CJQs that can be safely executed to be registered to the system.

The DSMS has a query processor 110 that can execute a plurality of CJQs 112. The query processor 110 receives data from a query register 120 that determines the safety of a particular CJQ. Safe CJQs are passed to the query processor 110, while unsafe CJQs are rejected and the rejection is back to the requester over a network 150 such as the Internet. Streams of data such as relational tuples and punctuations, among others, are sent over the network 150 and received by an input manager 130 which in turn provides the data stream to the query processor 110.

The query register 120 records a set of punctuation schemes which describe the types of punctuations that may be generated for a particular data stream (this information is typically derived from the application semantics). Before registering a continuous join query, the query register 120 checks if the query is safe from the available punctuation schemes. If it is safe, a safe query plan is generated and continuously executed for the incoming stream data. Otherwise, since it will require infinite space, this continuous join query will be rejected.

Each data stream Sᵢ has a relational schema (Aⁱ₁, . . . , Aⁱₙᵢ), where each Aⁱⱼ is an attribute. A continuous join query CJQ (S, P) can be defined over the data set of streams S={S₁, . . . Sₙ}, where P represents the set of join predicates among the data streams. Each of the join predicates p in P is specified on two data streams Sᵢ and Sⱼ. In one embodiment, the system handles commonly used equi-join predicate, i.e., Aⁱₓ=A^{j}_{y}(1≦x≦ni, 1≦y≦nj ) and conjunctive join predicates between any two data streams. Other kinds of join predicates and disjunctive join predicates are also contemplated.

Due to the unbounded nature of data streams, non-blocking join algorithms are suitable. For instance, a symmetric binary hash join algorithm can be used in the case of binary join operators and a generalized symmetric join algorithm can be employed for the MJoin operator.

When executing a continuous join query, inputs of each join operator need to be stored for future matches. The space used for storing the inputs of each join operator is referred to as the join states. In the case of a hash-based join algorithm, the join state of a join operator refers to the hash tables where the streaming data elements or the intermediate join results are hashed and stored.

In the following discussion, [symbol] ⁿ N denotes a join operator with n (≧2) inputs (either a binary join operator or an MJoin operator), and Yᵢ (i=1 . . . n) denotes the join states of [symbol] ⁿ. Future inputs are denoted as ΔYᵢ (i=1 . . . n). A tuple in Yᵢ needs to be stored as long as it can generate a result with any tuples in the future inputs. A join state Yᵢ is purgeable if for any tuple t in Yᵢ, there exists a mechanism to determine that t will not produce any join results with any new tuples in ΔYⱼ(j=1 . . . n). A join operator [symbol] ⁿ is purgeable if all n join states are purgeable.

An execution plan Γ(S,P) of a CJQ(S, P) contains m(≧1) join operators, i.e. [symbol] ⁿ^{₁}, . . . , [symbol] ⁿ^{ₘ}. The execution plan Γ(S,P) containing mjoin operators [symbol] ⁿ^{₁}, . . . , [symbol] ⁿ^{ₘ} is safe if every join operator [symbol] ⁿ^{ᵢ} is purgeable. Further, a CJQ(S, P) is safe if there exists at least one safe execution plan Γ(S,P).

When all the data streams are finite as in the conventional database case, the join states can be purged once all the streams are consumed. When dealing with sliding window type of continuous join queries, any tuples in the join states that move out of the time window can be purged. However, when neither of these conditions is applicable, the system needs to ensure the safety of continuous join queries under the punctuation semantics.

The safety problem can be addressed using punctuations. A punctuation P is a predicate on stream elements that must be evaluated to false for every element following the punctuation. There are many ways to represent punctuations. A punctuation for a data stream S(A₁, . . . , Aₙ) is formally defined as a set of predicates, one for each attribute Aᵢ(1≦i≦n). A predicate can be empty, denoted as “*”. This means that there is no constraint on a particular attribute for the future stream data. For example, in the online auction example discussed above, the punctuation for the bid stream which states that no more bids for the item with itemid=1 will arrive can be represented as (*, itemid=1, *), or simply (*, 1, *).

In one embodiment, the system uses a punctuation scheme concept to model the application semantics in terms of the formats of punctuations that a data stream S can have. For instance, in the online auction example, it only makes sense to have punctuations with equal-value predicates on the attribute itemid rather than on the attribute increase for the bid stream. A punctuation scheme P^{S} on a data stream S(A₁, . . . , Aₙ) can be defined as (P₁^{S}, . . . , Pₙ^{S}). For punctuations with equal-value predicate on attribute Aᵢ, then Pᵢ^{S}=“+”. In this case, the attribute Aᵢ is punctuable and the actual punctuation P is an instantiation of its corresponding punctuation scheme P^{S}. If there is no punctuation with equal-value predicate on attribute Aᵢ, then Pᵢ^{S} is denoted “_” and the attribute Aᵢ is not punctuable. In the last auction example, a punctuation scheme on the bid stream (_, +, _,_) denotes that punctuations with equal-value predicates may be available only on attribute itemid. A data stream Sᵢ may have more than one punctuation scheme. The query register 120 of FIG. 2 contains all the punctuation schemes defined in the DSMS for checking the safety of continuous join queries, referred to as punctuation scheme set, denoted by R.

The process through which punctuations affect the safety of a continuous join query is discussed next. A join state Yᵢ of a join operator [symbol] ⁿ is purgeable for a given punctuation scheme set R if for any tuple t in Yᵢ, there exists a finite set of punctuations {P} (with each P being an instantiation of one punctuation scheme in R) such that t will not produce any join results with any new tuples of the join states, ΔYⱼ=(j=1 . . . n). A join operator [symbol] ⁿ is purgeable if its all n join states are purgeable. An execution plan is safe if all its join operators are purgeable.

In the instant system, an execution plan is safe if and only if all its join operators are purgeable. In another word, the execution plan is safe if the query execution will not always consume infinite space. Additionally, in the system, a graph is called strongly connected if for every pair of vertices u and v there is a path from u to v and a path from v to u. The strongly connected components (SCC) of a directed graph are its maximal strongly connected subgraphs. These form a partition of the graph. “Strongly connected, strong connectivity and strongly connected sub-graphs” all correspond to the same meaning. In one embodiment, Kosaraju's algorithm can be used to compute the strongly connected components of a directed graph. A strongly-connected components (G) is determined as follows:
1. call DFS(G) to compute finishing times f[u] for each vertex u
2. compute G^{T}
3. call DFS(G^{T}), but in the main loop of DFS, consider the vertices in order of decreasing f[u]
4. produce as output the vertices of each tree in the DFS forest formed in point 3 as a separate SCC.

Even though it is impossible to predict which actual data or punctuations may come during the run-time, the safety checking using a given punctuation scheme set provides the guarantee that if one join state is not purgeable, then it can never be purged given any punctuations. Thus, such a query can not and should not be executed under the given set of punctuation schemes.

The safety of a CJQ using Punctuations can be determined as follows: a continuous join query CJQ(S, P) is safe if there exists at least one safe execution plan Γ(S,P). Given the same punctuation scheme set and CJQ, some execution plans are safe while others are not. The system selects execution plans by determining the safety of a query without enumerating all possible execution plans, which is computationally expensive.

The purgeability of the join states for a given punctuation scheme set is discussed next. For a Binary Join Operator, it is straightforward to determine the required punctuation schemes for a binary join operator's continuous and safe execution.

Assume that the two input data streams of a binary join operator [symbol] ² are S₁(A¹₁, . . . , A¹ₙ₁) and S₂(A²₁, . . . , A²ₙ₂), and the join predicate is A¹ᵢ=A²ⱼ. In order to purge a tuple t(a₁, . . . aᵢ, . . . aₙ₁) in the join state Y₁ for S₁, a punctuation of the form (*, . . . A²ⱼ=aᵢ, . . . *) from S₂ such that for any new tuples ΔY₂, t [symbol] Y₂ must evaluate to ø.

More generally, in order to purge any tuples in Y₁, a punctuation scheme P^{S} is used on S₂ with Pⱼ^{S}=“+”. A similar situation holds for purging the tuples in the join state Y₂. Multiple join predicates can be supported between two input streams. Thus, if the join predicates are A¹ᵢ₁=A²ⱼ₁̂ . . . ̂A¹ᵢₚ=A²ⱼₚ. A punctuation scheme P^{S} from S₂ with at least one Pₖ^{S}=“+” (k=n₁ . . . nₚ) suffices to purge the join state Y₁.

The system uses a chained purge strategy for the Mjoin operator under any arbitrary join predicates. First, a notion of join graph for an Mjoin operator is introduced. The join graph for a join operator [symbol] ² is a connected, undirected, labeled graph JG(V, E). Each vertex vᵢ in V represents one input stream Sᵢ for the join operator. Each edge, eᵢⱼ in E, between any two vertices vᵢ and vⱼ represents that there exists a join predicate between Sᵢ and Sⱼ.

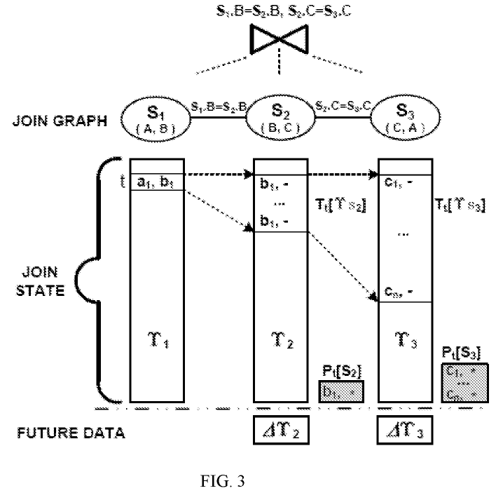

FIG. 3 shows an example 3-way join operator with three inputs S₁, S₂, S₃ and two join predicates S₁.B=S₂.B, S₂.C=S₃.C. Each vertex in the join graph corresponds to one input. There are two edges, namely, one between S₁ and S₂ and one between S₂ and S₃, denoting the two join predicates. In FIG. 3, the join states for S₁ S₂ and S₃ are Y_{S1}, Y_{S2} and Y_{S3} respectively. In order to purge a tuple t(a₁, b₁) from Y_{S1}, the system needs to ensure that it will not generate any new query results with either ΔY_{S2} and ΔY_{S3}.

First, the system considers how to ensure t [symbol] ΔY_{S2}=ø. The system looks for a punctuation from S₂ as (b₁, *) such that t [symbol] ΔY_{S2}=ø always holds. The joinable tuples in Y_{S2} with respect to t is defined as Tₜ[Y_{S2}]=Y_{S2} [symbol] t, where [symbol] denotes a semi-join. P₁[S₂] is the required punctuations from S₂ for purging tuple t. In this case, P₁[S₂]={(b₁, *)}.

Next, the system ensures that t [symbol] (Y_{S2}+ΔY_{S2}) [symbol] ΔY_{S3}=φ. Since t [symbol] ΔY_{S2}=ø, the system needs to make sure that t [symbol] Y_{S2} [symbol] ΔY_{S3}=ø. Since t [symbol] Y_{S2}=t [symbol] ΔY_{S2}(Y_{S2} [symbol] t)=t [symbol] Tₜ[Y_{S2}], the system only needs to guarantee that Tₜ[Y_{S2}] [symbol] ΔY_{S3}=ø is true. Further, if the distinct C attribute values of Tₜ[Y_{S2}] are {c₁ . . . cₙ}, from the discussions for the binary join case, punctuations (c₁, *), . . . , (cₙ, *) to ensure that Tₜ[Y_{S2}] [symbol] ΔY_{S3}=ø is true. The required punctuations are thus Pₜ[S₃]={(c₁, *), . . . , (cₙ, *)}.

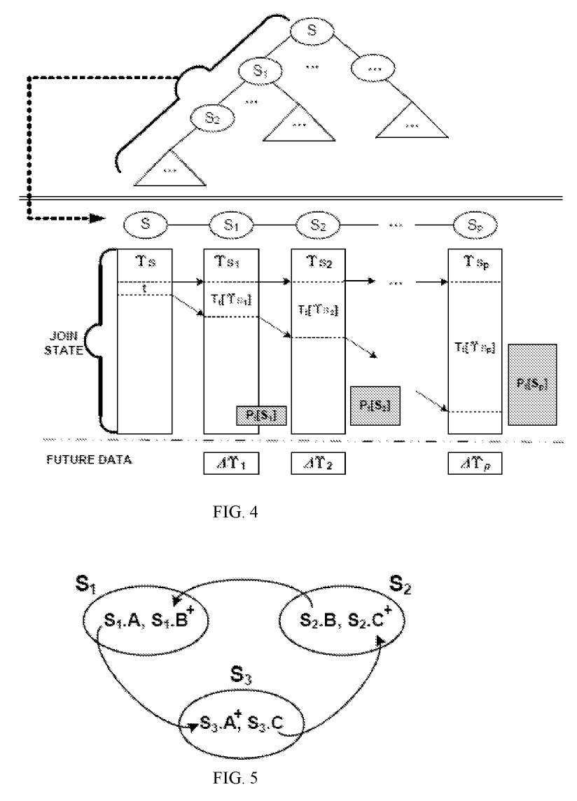

The above example shows that there is a chaining effect, which results in that streams that are not directly connected with t (in terms of join predicates) still have impact on the purgeability of t. This effect is used to develop a chained purge strategy. First, consider an acylic join graph. For any node S in the join graph, a spanning tree can be obtained from the join graph rooted at S as shown on the top of FIG. 4. Now, consider any root-to-leaf path S->S₁, . . . , ->Sₚ, with join predicates for each edge as S.A₁=S₁.A₁, S₁.A₂=S₂.A₂, . . . , Sₚ₋₁.Aₚ=Sₚ.Aₚ. In order to purge any tuple t in S, the system ensures that t cannot generate any new query results with ΔY_{S1}, . . . , ΔY_{Sp}. The required punctuations Pₜ[Sᵢ] for each Sᵢ in order to purge t is described next:
Step 1: Punctuations Pₜ[S₁] are needed with a set of predicates on S₁.A₁, whose values come from δ_{A1}(t). With Pₜ[S₁], t [symbol] ΔY_{S1}=ø always holds. The joinable tuples in Y_{S1} are defined with respect to t as Tₜ[Y_{S1}]=Y_{S1} [symbol] t for the next step.
Step 2: Punctuations Pₜ[S₂] are needed with a set of predicates on S₂.A₂, whose values come from δ_{A2}(Tₜ[Y_{S1}]). With Pₜ[S₂], t [symbol] Y_{S1} [symbol] ΔY_{S2}=ø always holds. From the previous discussion, t [symbol] ΔY_{S1}=ø. Together, t [symbol] (Y_{S1}+ΔY_{S1}) [symbol] ΔY_{S2}=ø must hold. The joinable tuples in Y_{S2} are defined with respect to t as Tₜ[Y_{S2}]=Y_{S2} [symbol] Tₜ[Y_{S1}] for the next step.
Step i: Punctuations Pₜ[Sᵢ] are defined with a set of predicates on Sᵢ.Aᵢ, whose values come from δ_{Ai}(Tₜ[Y_{Si-1}]). With Pₜ[Sᵢ], t [symbol] Y_{S1} . . . [symbol] ΔY_{Si-1} [symbol] Y_{Si} must evaluate to ø.

From the above discussion:

t [symbol] ΔY_{S}_{₁}=ø,

t [symbol] (Y_{S}_{₁}+ΔY_{S}_{₁}) [symbol] ΔY_{S}_{₂}=ø,

. . .

t [symbol] (Y_{S}_{₁}+ΔY_{S}_{₁}) [symbol] . . . [symbol] (Y_{S}_{ᵢ₋₂}+ΔY_{S}_{ᵢ₋₂}) [symbol] ΔY_{S}_{ᵢ₋₁}=ø.

Together, t [symbol] (Y_{S}_{₁}+ΔY_{S}_{₁}) [symbol] . . . [symbol] (Y_{S}_{ᵢ₋₂}+ΔY_{S}_{ᵢ₋₂}) [symbol] (Y_{S}_{ᵢ₋ₜ}+ΔY_{S}ᵢ₋₁) [symbol] ΔY_{S}_{ᵢ}=ø must hold. We then define the joinable tuples in Y_{S}_{ᵢ} with respect to t as Tₜ[Y_{S}_{ᵢ}]=Y_{S}_{ᵢ} [symbol] Tₜ[Y_{S}_{ᵢ₋₁}] for the next step.

Based on the above chained purge strategy, the punctuation scheme P^{S} required for each Sᵢ must have Pᵢ^{S}=“+”, i.e., there are punctuations on Sᵢ.Aᵢ. When the join graph is cyclic, there exists multiple ways to purge a join state. FIG. 3 shows an additional join predicate, S₁.A=S₃.A. An alternative way to purge the tuples in Yₛ₁ would be to first use the punctuations in S₃ on A and then use the punctuations in S₂ on C. The system then checks when such a chained purge strategy is applicable under a given set of punctuation schemes for any arbitrary join graph.

An exemplary safety checking process is described next. The system uses a graph model named punctuation graph which captures the relationship between join predicates and the corresponding punctuation schemes. In the following discussion, [symbol] ⁿ is a join operator where T represents the set of its input data streams and P represents the set of join predicates. The punctuation graph of [symbol] ⁿ under a given punctuation scheme set R is a directed graph denoted by PG^{R}( [symbol] ⁿ).

Assume that V represents the set of vertices and E represents the set of directed edges in PG^{R}( [symbol] ⁿ). Each node of PG^{R}( [symbol] ⁿ) represents a data stream involved in [symbol] ⁿ, i.e., V=T. The directed edge between any two nodes Sᵢ and Sⱼ are defined in the attribute granularity. For any join predicate Aⁱₓ=A^{j}_{y} in P, if there exists a punctuation scheme in R with P^{Si}ₓ=“+”, then there is a directed edge from A^{j}_{y} to Aⁱₓ, and vice versa. The punctuation graph of a continuous join query can be defined in the same way.

FIG. 5 shows the punctuation graph of a 3-way join operator under a given punctuation scheme set. As shown in FIG. 5, the 3-way join operator has three data streams involved, S1, S2, S3. The set of join predicates is P={S1.b=S2.B, S2.C=S3.C, S3.A=S1.A}. The given punctuation scheme set given is R={(_, +), (_, +), (_, +)}. Thus, the punctuation graph has three nodes, namely S1, S2, S3 as shown in FIG. 5. Then the directed edges are constructed among nodes by checking the join predicates in P and the punctuation schemes in R as well. For instance, for the join predicate S1.B=S2.B, there exists a punctuation scheme of (*, S1.B) in R. Hence, there is a directed edge from S2.B to S1.B.

The algorithm for constructing the punctuation graph of a multi-way operator under a given punctuation scheme set R is summarized as in Algorithm 1. The time complexity is linear in the size of the input streams, predicates and the punctuation scheme set, i.e., O(∥T∥+∥P∥+∥R∥).

The algorithm for Construct PG is as follows:

Algorithm 1 ConstructPG

```
Input: [symbol] ⁿ( [symbol] , [symbol] , [symbol]
Output: PG [symbol] ( [symbol] ⁿ)
  1: PG [symbol] ( [symbol] ⁿ) = (V(Φ),E(Φ));
  2: for each Sᵢ ∈ [symbol] do // build vertices
  3:  V.add(Sᵢ);
  4: end for
  5: map = buildHashMap( [symbol] );
  6: for each p of (Aₓⁱ = A_{y}^{j}) ∈ [symbol] do
  7:  if map.contains(Aₓⁱ) then
  8:  E.add(A_{y}^{j} → Aₓⁱ);
  9:  end if
10:  if map.contains(A_{y}^{j}) then
11:  E.add(Aₓⁱ → A_{y}^{j})
12:  end if
13: end for
14: return PG [symbol] ( [symbol] ⁿ);
```

The condition in which the join state of an input stream of a join operator is required to be purgeable based on the punctuation graph is discussed next. Assume that [symbol] ⁿ represents a join operator with n input data streams {S1 . . . Sn}, and PG^{R}( [symbol] ⁿ) represents the punctuation graph of [symbol] ⁿ under a punctuation scheme R, the join state of an input data stream involved in a join operator [symbol] ⁿ is purgeable under a given punctuation scheme set R. The system determines that the join state of an input data stream Si involved in a join operator [symbol] ⁿ is purgeable under a given punctuation scheme set R if there must exist a path from Si to every other node Sj in the punctuation graph PG^{R}( [symbol] ⁿ). A join operator [symbol] ⁿ with S1, . . . , Sn as input data streams is purgeable under a given punctuation scheme set R if its punctuation graph under R, PG^{R}( [symbol] ⁿ), is a strongly connected graph.

Next, the safety checking of a CJQ is discussed. A continuous join query can be executed by a execution plan of an MJoin operator only, a tree of MJoin operators, a tree of binary join operators, or a tree of binary join operators and MJoin operators. An execution plan is safe if and only if every join operator involved is purgeable. In order to show that a continuous join query can be safely executed, a safe physical query plan is needed. Since there exist exponential number of execution plans for a continuous query, the system cannot afford to enumerate all possible such plans and determine if each of them is safe or not. Also the following example shows that the same punctuation schemes may be safe for some execution plans and may NOT be safe for other execution plans. For instance, if an execution plan using a tree of binary join operators is adopted to execute the continuous 3-way join query in FIG. 5, which is now executed by the MJoin operator, i.e., S1 joins with S2 first and their intermediate results merged into stream S0 joins with S3 to produce the join results, then the execution plan will not be safe under the same given punctuation scheme set. This is due to the fact that there is no mechanism to purge the tuples from S1. Hence, if the punctuation join graph PG^{R}(CJQ) for CJQ(T, P) under a given punctuation scheme set R is a strongly connected graph, then CJQ(T, P}) can be safely executed under R. From the condition, there must exist a safe physical query plan for the continuous join query, which has an only MJoin operator with S1, . . . , Sn as input data streams. The algorithm for CJQ Safety is as follows:

Algorithm 2 CJQSafetyChecking

```
Input: CJQ( [symbol] , [symbol] , [symbol]
Output: true (safe) / false (unsafe)
  1: // construct the punctuation graph
  2: PG [symbol] (CJQ) = ConstructPG(CJQ [symbol] , [symbol] , [symbol] ;
  3: // check if the punctuation graph is
  4: // a strongly connected one
  5: safe = IsStronglyConnected(PG [symbol] (CJQ));
  6: return safe;
```

The algorithm to determine whether a directed graph is strongly connected has a linear time complexity in terms of the size of vertices and edges. Hence, the time complexity for the function IsStronglyConnected is O(∥T∥+∥P∥). Since the time complexity for ConstructPG is O(∥T∥+∥P∥+∥R∥), the time complexity for the safety check is O(∥T∥+∥P∥+∥R∥).

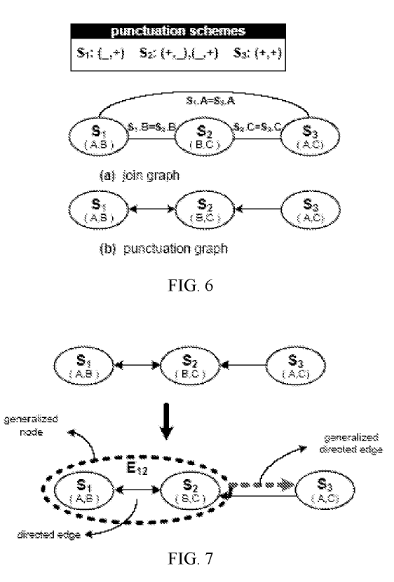

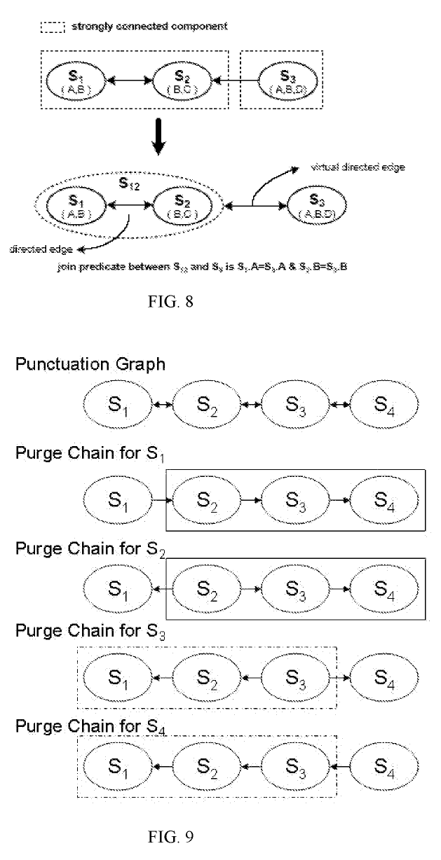

Next the safety checking of CJQs with the case of punctuation schemes having only one punctuatable attribute is discussed. Consider the 3-way join operator as shown in FIG. 6 but with the available punctuation scheme set R={S1(_,+), S2(+,_), S2(_,+), S3(+,+)}. The join graph and punctuation graph of the 3-way join operator under R are shown in FIG. 8(a) and (b) respectively. Based on previous result, this 3-way join operator is not purgeable since its punctuation graph is not strongly connected. However, the 3-way join operator is actually purgeable in that (i) the join state of S3 is purgeable according to Theorem 1; (ii) the join state of S1 is purgeable as can be explained as follows. Assume that t(a1; b1) is a tuple from S1. In order to make sure that t is not joinable with new data coming into S2, a punctuation (b1, *) from S2 is needed, which can be instantiated by the punctuation scheme S2(+,_). Furthermore, assume that t's joinable tuples in S2 are (b1, c1), . . . , (b1, cm). If punctuations of (a1,c1), . . . , (a1,cm) in S3 instantiated from the punctuation scheme S3(+, +), together with the punctuation (b1, *) are present, the system can decide t is not joinable with any new data coming into S2 and S3; (iii) following the similar explanation for S3, the join state of S2 is also purgeable.

A generalized chained purge strategy is then discussed to handle the above issue. When the system develops the chained purge strategy for the case of punctuation schemes with only one punctuatable attribute, in step i, in order to make sure t [symbol] Y_{S}_{₁} [symbol] . . . [symbol] Y_{S}_{ᵢ₋₁} [symbol] ΔY_{S}_{ᵢ}=ø, the system only needs to have the punctuations related to the joinable tuples of t from the previous step. Nevertheless, when punctuation schemes with multiple punctuatable attributes are present, the punctuations related to some/all the join tuples of t from some/all of the previous steps may also suffice to guarantee that t [symbol] Y_{S}_{₁} [symbol] . . . [symbol] Y_{S}_{ᵢ₋₁} [symbol] ΔY_{S}_{ᵢ}=ø. More specifically, let's take a look at the path from S to Sp as shown in FIG. 4. In step i, assume that Si has m-1 extra join predicates with m-1 data streams along the path from S to Si-1 in which the involved join attributes are Aᵢ_{₁}, . . . , Aᵢ_{ₘ₋₁}. To ensure that a tuple t from S is not joinable with any new data from Si, a punctuation scheme P from Si with the punctuatable attributes from a subset of Aᵢ, Aᵢ_{₁}, . . . , Aᵢ_{ₘ₋₁} will suffice to generate a finite number of punctuations to guarantee that. This is to generalize the chained purge strategy to handle the case of punctuation schemes with multiple punctuatable attributes.

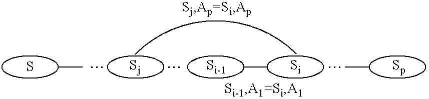

Next a generalized punctuation graph is discussed. In addition to the punctuation mentioned earlier, extra nodes and edges will be added. Assume that a data stream Si involved in [symbol] ⁿ has a punctuation scheme P with m punctuatable attributes, Aᵢ_{₁}, . . . , Aᵢ_{ₘ}, and they are involved as join attributes with data streams Aᵢ_{₁}, . . . , Sᵢ_{ₘ} respectively. The system creates an generalized node which covers Sᵢ_{₁}, . . . , Sᵢ_{ₘ} and a generalized directed edge {Sᵢ_{ⱼ}}→Sᵢ. FIG. 7 depicts such a sample generalized punctuation graph.

Based on the notion of generalized punctuation graph, a transformation algorithm (Algorithm 3) is discussed. FIG. 8 depicts an example for transforming the generalized punctuation graph in FIG. 7.

Algorithm 3 Transforming Generalized Punctuation Graph

| 1. | Find the strongly connected components; | |
|---|---|---|
| 2. | Virtual node construction: for each strongly connected component with | |
| | more than one node, merge them into one new virtual node while keeping | |
| | the structural relationship among the nodes within the strongly connected | |
| | component; | |
| 3. | Virtual directed edge construction: for any pair of nodes S′i and S′j with at | |
| | least one of them as a virtual node, the join predicate between them is the | |
| | conjunction of the join predicates, which correspond to the streams covered/ | |
| | represented by S′i and S′j. | |
| | (i) | directed edge promotion: if there exists a directed edge between their covered |
| | | nodes, then this directed edge is promoted to be as a virtual directed edge |
| | | between S′i and S′j. |
| | (ii) | after the directed edge promotion, if there is still no directed edge from S′i |
| | | to S′j and S′i is a virtual node, and there exists a punctuation scheme P from |
| | | one of the streams covered by S′j (virtual node) or the stream S′j itself whose |
| | | punctuatable attributes are a subset of the join attributes from S′j, then add a |
| | | new virtual directed edge from S′i to S′j. |

| | |
|---|---|
| 4. | Continue 1~3 until the transformed punctuation graph is strongly connected or there |
| | does not exist any strongly connected component with more than one node in the |
| | transformed punctuation graph. |

Hence, if the generalized punctuation join graph for CJQ(T, P) under a given punctuation scheme set R can be transformed into a single node based on the above algorithm, then CJQ(T, P}) can be safely executed under R.

Next, an efficient chained purge strategy execution algorithm is discussed. The main idea is to share the common purging across multiple purge chains. FIG. 9 shows an example punctuation graph, which involves four data sources. The corresponding four chains for purging individual sources are also shown in the figure. The two solid rectangular boxes show that there are common purging sub-chains between S1 and S2. The two dotted rectangular boxes show that there are common purging sub-chains between S3 and S4. Hence rather than purging S1 to S4 individually, the common purging of the common sub-chains can be shared.

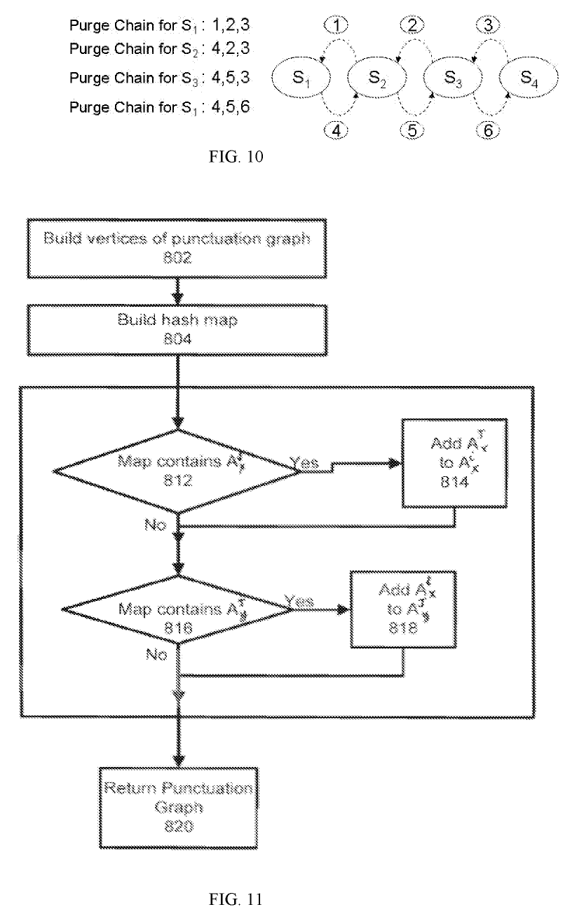

The solution to achieve the shared purging is to adapt a peer propagation mechanism. FIG. 10 shows the example. There are six peer propagation edges (shown as dotted edges in the figure) for the punctuation graph in FIG. 9. The purging of S1 to S4 shares those peer propagation as also shown in the figure. For instance, the peer propagation 2 is shared by S1 and S2, while the peer propagation 4 is shared by S2, S3 and S4. Hence, shared purging is achieved.

Next, the method for peer propagation is discussed. The concept peer chain is defined based on the path in the peer propagation graph. For example, in FIG. 10, there are two peer chains, namely, 3→2→1 and 4→5→6. The peer propagation starts from the root of the peer chains, i.e., 3 and 4. For a given node Si in a chain, the punctuation instance at Si can be propagated to its next neighbor in the peer chain if it is guaranteed to not produce any result with the new tuples from the ancestor sources in the peer chain. This is based on the chained purge strategy. Algorithm 4 below details this algorithm.

Algorithm 4 Peer Propagation for Si

```
Assmuption: Si is on two peer chains from
S1→...→Si−1→Si→Si+1→...Sn
          and S1←...←Si−1 ← Si ← Si+1 ← ... Sn
Case 1: Get a propagated punctuation from Si−1;
  Determine if any punctuation instance p of Si can be propagated
  to Si+1:
  p can propagated iff p cannot produce any join results with any new
  tuples at S1...Si−1
Case 2: Get a propagated punctuation from Si+1;
  Determine if any punctuation instance p of Si can be propagated
  to Si−1:
  p can propagated iff p cannot produce any join results with any new
  tuples at Si+1...Sn
Case 3: Determine if tuples at Si can be purged;
  A tuple at Si that corresponds to a punctuation instance at Si−1 and a
  punctuation instance at Si+1 can be purged
```

A punctuation helps not only purge the tuples from the current join states, but also purge “future” tuples. Therefore, early removal of the punctuations from the system is potentially hazardous. For example, in FIG. 3, if the punctuation (b1; *) from the data stream S₂ is simply discarded after purging the tuple (a₁; b₁) in S1, then any new tuples from S₁ whose attribute B has value b₁ can no longer be purged. Of course, this is not acceptable. On the other hand, storing all the punctuations infinitely is also not acceptable, as this may lead into infinite memory requirements (i.e., unsafety of the system). Thus, the safety checking of a CJQ should involve two kinds of purgeability: data purgeability and punctuation purgeability.

A punctuation can be treated a special tuple and, similar to the normal stream data, punctuations can also be purged by the corresponding punctuations from other streams. For instance, in the example of FIG. 3, the punctuation (*; b₁) from S₁ not only helps to remove the tuples in S₂ whose attribute B has value b₁, but also helps to remove the punctuation (b₁; *) from S₂. The reason is that since there will be no more tuples from S₁ whose attribute B has value b₁, (b₁; *) from S₂ no longer needs to be kept. However, purging a normal stream tuple and purging a punctuation are not identical. A normal stream tuple can be purged by punctuations on any of its join attributes, while a punctuation can only be purged by the punctuations on its non-* attributes. For instance, in FIG. 3, a tuple (a₁; b₁) from S₁ can be purged by either a punctuation (b₁; *) from S₂ or a punctuation (*; a₁) from S₃, while the punctuation (*; b₁) from S₁ can only be purged by the punctuation (b₁; *) from S₂. However, punctuations on non-* attributes can render punctuation purging costly in terms of the number of punctuation schemes that need to be supported.

In one embodiment, punctuations have lifespans. As a concrete example, consider the format of a TCP/IP packet depicted in FIG. 8. For network monitoring applications, a punctuation on both sequence numbers and source IP address may be generated denoting the end of one transmission. According to the TCP RFC, the sequence number at a TCP source will cycle approximately every 4.55 hours. This means that such a punctuation has a lifespan for about 4.55 hours. After that, the punctuation expires and can be ignored (i.e., it is implicitly purged). Additionally, punctuations can be missed due to the network transmission problems or the application errors. Thus, a background clean-up mechanism can be used to remove the corresponding non-purged data. Since cleaning missed non-purged data is much cheaper than cleaning all the data, data purgeability alone can guarantee the safety of continuous join queries.

Next, the selection of a Safe Execution Plan is discussed. A continuous join query CJQ may be safely executed in numerous ways under a given punctuation scheme set. Among all possible safe plans, it is of course desirable to pick one with minimum cost. Similar to any traditional query optimization task, this involves plan enumeration and cost estimation. In this context, plan enumeration means the enumeration of possible safe execution plans, while cost estimation refers to the estimation of the cost for each individual plan.

In Plan Enumeration, given the available punctuation schemes, the number of safe plans is typically much smaller than the number of all possible plans. Thus, rather than first enumerating all possible plans and then checking whether they are safe or not, it is more desirable to generate only the safe plans in the first place. An execution plan is safe if all of its MJoin operators (including the binary join operators) are purgeable. Additionally, each individual MJoin operator is purgeable if its punctuation graph is strongly connected. Based on these results, any strongly connected sub-graphs in the punctuation graph for the query could serve as building blocks for constructing safe plans. A dynamic programming approach (similar to the classic system R optimizer) can be used to construct the query plan from small strongly connected sub-graphs.

As far as the cost estimation, punctuations have both costs (in terms of punctuation generation and real-time processing) and benefits (in terms of memory gains, reduced blocking). Therefore, cost estimation is part of a cost/benefit analysis. Since there are many (sometimes conflicting) parameters, such as the data arrival rate, punctuation arrival rate, and join selectivities, involved the goals of the optimization itself may be contradictory: for the simplest example, consider that one may optimize for memory usage and throughput; but these are not always complementary.

Two concrete plan parameter examples and their cost benefit impacts will be discussed next. For an MJoin operator, a plan parameter can be used to determine which alternative punctuation (schemes) to use. As two extreme cases, consider that the system may (a) either choose to use all punctuation schemes available to it, or (b) use only the minimum number of punctuation schemes that will keep the punctuation graph strongly connected. Option (a) is likely to reduce the memory usage for data; but it will increase the memory usage (and the processing cost) for punctuations. Option (b) on the other hand will provide savings in terms of punctuations, but will increase the memory usage for data. Another plan parameter can determine which runtime purge strategy will be used. A runtime purge strategy can be either eager or lazy: eager purge strategy processes the punctuations as soon as they arrive, while lazy purge strategy handles punctuations in a batched fashion. Different strategies have different impacts on the overall memory usage and system throughput. Therefore, based on the optimization goals, different purge strategies may be applicable. In one embodiment, adaptive query processing can be used to improve the accuracy of the cost model as the system characteristics rapidly change. Such rapid changes and fluctuations are common in a streaming environment.

Referring now to FIG. 11, a process to construct a punctuation graph is shown. The process first builds vertices of the punctuation graph (802). Next, the process builds a hash map (804). Then for each punctuation, the following is done (810): the process checks to see if the hash map contains A^{j}ₓ (812). If so, the process adds A^{j}ₓ to Aⁱₓ (814). Alternatively, the process checks to see if the map contains A^{j}ₓ (816) and if so, the process adds Aⁱₓ to A^{j}ₓ (818). The process then returns the punctuation graph (818) and exits.

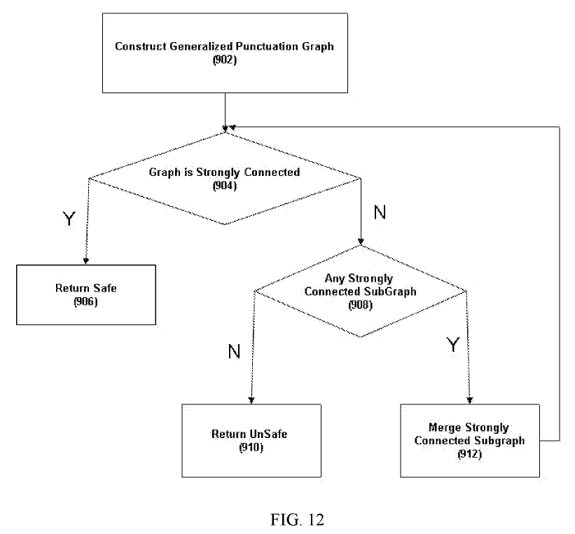

Referring to FIG. 12, a process to perform CJQ safety checking is shown. The process first constructs a generalized punctuation graph as shown in FIG. 7 (902). Next, the process determines whether the punctuation graph is strongly connected (904). If so, the process returns a flag indicating that the CJQ is safe to execute (906). If not, the strongly connected sub-graph is merged (908) and 904 is repeated. If there is no such strongly connected sub-graph, the process returns a flag indicating that CJG is not safe to execute (910).

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method to guarantee a safety of a continuous join query (CJQ) over one or more punctuated data streams, comprising:
generating a punctuation graph representing relationships between one or more punctuation schemes and join conditions; and
indicating that the CJQ is safe to execute when the punctuation graph is strongly connected.

2. The method of claim 1, comprising applying a chained purge strategy as the basis for safety checking of continuous join queries.

3. The method of claim 1, comprising defining a punctuation graph based on punctuability of join attributes.

4. The method of claim 1, comprising determining the safety of the CJQ based on the strong connectivity of punctuation graph.

5. The method of claim 1, comprising guaranteeing the safety of a continuous join query (CJQ) under punctuation schemes over more than one attribute, comprising:
generating a generalized punctuation graph representing relationships between one or more punctuation schemes and join conditions for checking the safety of the CJQ;
transforming the generalized punctuation graph by repetitively merging strongly connected sub-graphs; and
indicating that the CJQ is safe to execute if the merged result is a single node.

6. The method of claim 5, comprising applying a generalized chained purge strategy that serves as the basis for the safety checking of CJQs.

7. The method of claim 5, comprising defining the generalized punctuation graph when the punctuation schemes have more than one attribute by introducing virtual combined nodes.

8. The method of claim 5, comprising determining the safety of the CJQ by continuously analyzing strongly connected sub-graphs in the generalized punctuation graph.

9. A method to share a chained purge for a multi-way join operator, comprising:
deriving multiple peer chains for a multi-way join operator; and
generating a protocol of peer propagation for propagating punctuations to neighboring join operands.

10. The method of claim 9, comprising sharing one or more purge chains for a multi-way join operator using the peer chains.

11. The method of claim 9, comprising determining the peer chains of a multi-way join operator.

12. The method of claim 9, comprising performing peer propagation in a peer chain.

13. A method, comprising determining purgeability of the punctuations, comprising:
determining the format of punctuations that can purge another punctuation; and
providing management of punctuation purgeability.

14. The method of claim 13, comprising the purge of a punctuation requires another punctuation on non-* attributes.

15. The method of claim 13, wherein each punctuation instance has a lifespan.

16. A method to generate a query plan enumeration based on one or more predetermined objectives, comprising:
enumerating one or more safely executable candidate query plans; and
estimating the cost of each candidate query plan.

17. The method of claim 16, comprising enumerating the query plan from strongly connected sub-graph.

18. The method of claim 16, comprising enumerating the query plan by considering a purging cost and a query execution cost.
